(19) United States
(12) Patent Application Publication
(10) Pub. No.: US 2025/0074006 A1
(43) Pub. Date: Mar. 6, 2025

(54) OBSERVATION AND CONTROL OF POWDER BED FUSION PROCESSES VIA MELT DETECTION

(71) Applicant: BRIGHAM YOUNG UNIVERSITY, Provo, UT (US)

(72) Inventors: Nathan Crane, Vineyard, UT (US); Derek Black, Albuquerque, NM (US)

(73) Assignee: BRIGHAM YOUNG UNIVERSITY, Provo, UT (US)

(21) Appl. No.: 18/945,202

(22) Filed: Nov. 12, 2024

Related U.S. Application Data
(63) Continuation of application No. 18/818,572, filed on Aug. 28, 2024.
(60) Provisional application No. 63/534,980, filed on Aug. 28, 2023.

(51) Int. Cl. B29C 64/393; B29C 64/153; B33Y 10/00; B33Y 50/02

(52) U.S. Cl. CPC B29C 64/393; B29C 64/153; B33Y 10/00; B33Y 50/02

(57) ABSTRACT

Disclosed is a method for observing and controlling powder melting in a 3-dimensional printer receiving input from a computing device. The 3-dimensional printer initiates the melting of powder on a powder bed. The 3-dimensional printer receives real-time feedback based on information from one or more optical sensors. The 3-dimensional printer adjusts output based on feedback from the optical sensors, and the 3-dimensional printer executes the melting of the powder on the powder bed based on the adjustments.

### BACKGROUND

This application claims the priority and benefit of U.S. Provisional Patent Application No. 63/534,980 filed on Aug. 28, 2023, and Nonprovisional application Ser. No. 18,818,572 filed on Aug. 28, 2024, which are incorporated by reference in their entirety.

Polymer powder bed fusion (PBF) technologies have their origins in the early developments of additive manufacturing, commonly known as 3D printing. Powder bed fusion refers to a group of additive manufacturing processes that use thermal energy to selectively fuse areas of a polymer powder bed to create a three-dimensional part layer by layer. This method offers the advantage of producing highly detailed, complex geometries that are difficult or impossible to fabricate using traditional manufacturing techniques.

The initial advances in powder bed fusion for polymers trace back to the development of Selective Laser Sintering (SLS) in the mid-1980s. Carl Deckard and colleagues at the University of Texas pioneered the concept, using a high-power laser to selectively fuse polymer powder particles layer by layer to form parts. This process laid the foundation for modern polymer PBF technologies, where powdered thermoplastic polymers are melted and fused by a heat source and solidified into a solid object upon cooling.

The SLS process, which primarily uses lasers to sinter or melt polymer powders, gained widespread popularity due to its ability to produce durable, complex parts with good mechanical properties. Over the years, further innovations have been made to improve material properties, part quality, and the efficiency of the manufacturing process.

In addition to SLS, other PBF methods were developed, such as multi-jet fusion (MJF), which introduced a novel approach by using inkjet printing technology in conjunction with an energy source. MJF fuses powdered polymers through the application of chemical agents, followed by exposure to infrared radiation, resulting in a more uniform heating and higher production speeds than traditional SLS. The goal of these technologies is to maximize precision, minimize production time, assure product quality, and expand material options, all while enabling the production of high-performance parts suitable for end-use applications.

Despite these advances, the traditional PBF processes faced limitations in terms of build speed and scalability. As the demand for higher throughput and larger-scale production grew, attention turned to enhancing PBF techniques to handle large surface areas while maintaining the precision and material properties of earlier methods.

This demand for higher scalability and production speed paved the way for Large Area Projection Sintering (LAPS), a newer evolution in polymer powder bed fusion technology. LAPS builds upon the fundamental principles of PBF but replaces the point-by-point scanning of a laser or other energy sources with large-area projection systems. In LAPS, an entire layer of powder can be sintered simultaneously using a high-resolution, large-area energy source, such as a digital light projector or array of infrared lamps. By sintering entire regions of the powder bed in a single step, this technology dramatically increases the speed of production and reduces the time needed to manufacture larger parts and allows for processing of a wider range of materials with improved material properties.

The introduction of LAPS marks a significant advancement in powder bed fusion for polymers, enabling more efficient, scalable production while preserving the high precision and mechanical properties characteristic of traditional PBF methods. This process holds great promise for large-scale manufacturing and is poised to meet the growing industrial demand for high-performance, additively manufactured polymer parts. However, monitoring and controlling the process in real-time can be difficult but the ability to do so could increase the quality of the printed object and increase the ability to create the same object with the same physical traits.

### SUMMARY OF THE DISCLOSURE

Disclosed herein is a system and a method for observation and control of powder bed fusion.

### BRIEF DESCRIPTION OF THE DRAWINGS

Non-limiting and non-exhaustive implementations of the disclosure are

described with reference to the following figures, wherein like reference numerals refer to like parts throughout the various views unless otherwise specified. The advantages of the disclosure will become better understood with regard to the following description and accompanying drawings where:

FIG. 1 illustrates a method of control and observation of powder melting via melt detection.

FIG. 2 illustrates light reflection based on the geometry of the surface.

FIG. 3 illustrates light reflection based on the geometry of the surface.

FIG. 4 illustrates a correlation between magnified images of the powder bed and the intensity profile.

FIG. 5 illustrates an optical observation configuration for observing powder melting.

FIG. 6 illustrates an optical observation configuration for observing powder melting.

FIG. 7 illustrates an optical observation configuration for observing powder melting.

FIG. 8 illustrates a schematic diagram of the observation of powder melting fusion via melt detection.

### DETAILED DESCRIPTION

In the following description of the disclosure, reference is made to the accompanying drawings, which form a part hereof, and which are shown by way of illustration-specific implementations in which the disclosure may be practiced. It is understood that other implementations may be utilized, and structural changes may be made without departing from the scope of the disclosure.

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure may be alternatively included in another embodiment or figure regardless of whether or not those elements are shown or described in another embodiment or figure. In other words, elements in the figures may be interchangeable between various embodiments disclosed herein, whether shown or not.

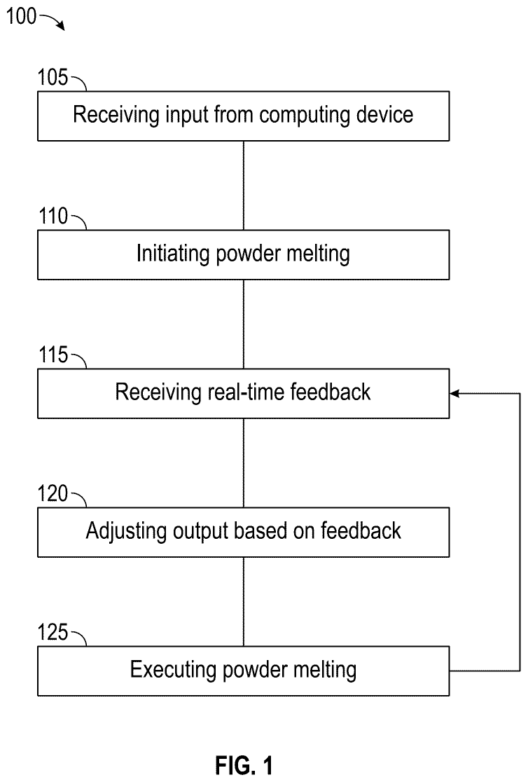

FIG. 1 illustrates method 100 for control and observation of 3-dimensional printer via melt detection. Method 100 may include step 105 receiving input from a computing device. The computing device may relay the schematic information needed to print the desired 3-D object. This includes information on the dimensions of the particular 3D object, the slicing information, the printing parameters, the material data, the support structures, and the printing calibration and configuration needed. The communication between the 3-dimensional printer and the computing device may be a direct connection or indirectly connected through a type of network. The computing device may also indicate to the 3-dimensional printer the one or more sensors that will be involved in the observation of the melt detection. In that manner, the one or more sensors may communicate directly to the 3-dimensional printer or through the computing device. Further, sensors may be specialized to the point of determining via melt detection the adjustments that the powder bed printer needs to make and relaying such information directly or indirectly to the 3-dimensional printer.

Step 110 may include initiating the powder melting. This step may include initiating the series of tasks needed to produce a 3D object as designated by a computing device. These steps may include but are not limited to material preparation which may include loading and spreading the powder. Activating energy source be it a laser, electron beam, infrared heater, plasma arc, or visible light projector. Cooling time may be required. Adjustments may be made based on the sensor input described in steps 120 and 125. This process may be repeated until the desired object is complete. Post processing steps may be needed. The computing device may be able to receive and interpret input from one or more sensors. The one or more sensors may be an optical sensor and be pointed at the powder bed where the powder melting is taking place. Sensors could be used to validate the density of each layer prior to the fusing of subsequent layers.

In step 120 the sensors may provide real-time feedback to allow for adjustments. Each step 105-130 may occur using a computing device that can relay the information received by the sensors to the 3-dimensional printer. The computing device best fit to handle the operation of relaying the information is capable of fast computations. Also, machine learning may be involved when providing feedback or making adjustments based on the feedback. Feedback may be relayed to the 3-dimensional printer by the computing device or by one or more sensors directly or indirectly. To that end, sensors may include a processor to permit communication with the computing device or the 3-dimensional printer. Further, the instruction relayed to the 3-dimensional printer may include raw information and or commands from either the printer or the one or more sensors.

Once feedback is received by the 3-dimensional printer adjusting output by the powder bed printer may take place in step 125. Adjustments may include but are not limited to the durations and/or the intensity of the energy/light source or adjustment of the geometric area of the projection. After adjustments are made in step 125 of step 130 may include executing powder melting according to the adjustments made based on the sensor input. From step 130 method 100 may include returning back to step 115 once a layer is complete where the one or more sensors are monitoring the optical melting states to move onto step 120 and then to step 125 and this process may repeat until the object has been produced.

In step 115 the sensors may provide real-time feedback to allow for adjustments. Each step 105-125 may occur using a computing device that can relay the information received by the sensors to the 3-dimensional printer. The computing device best fit to handle the operation of relaying the information is capable of fast computations. Also, machine learning may be involved when providing feedback or making adjustments based on the feedback. Feedback may be relayed to the 3-dimensional printer by the computing device or by one or more sensors directly or indirectly. Further, the instruction relayed to the 3-dimensional printer may include raw information and or commands from either the printer or the one or more sensors.

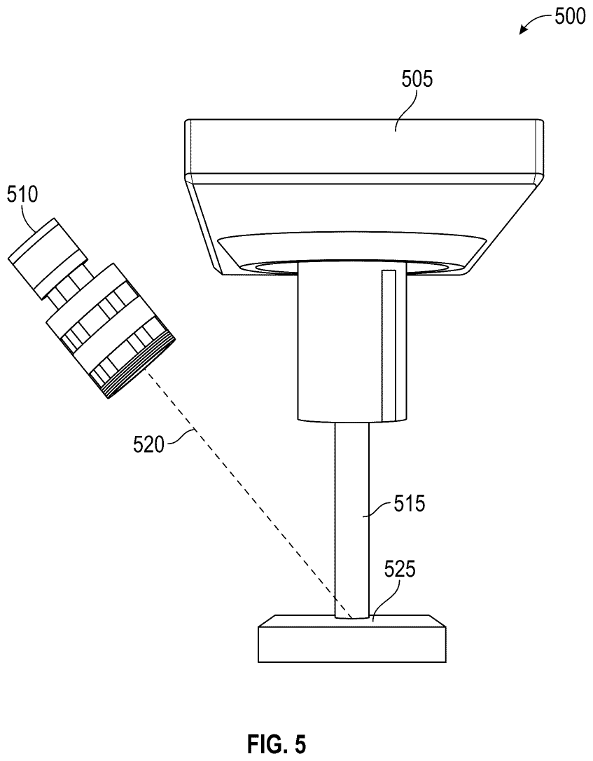

In step 115 some of the real-time feedback may include optical melting states provided by one or more sensors. The sensors may include one or more types of cameras, including but not limited to optical cameras, thermal cameras, high-speed cameras, magnified cameras, high-speed X-rays, scanning electron microscopes, etc. Alternatively, the optical sensor may also be a photodiode. The sensor and the light sources may be positioned orthogonally in such a manner that the one or more sensors may be positioned in a dark-field configuration as depicted in FIGS. 5-7. In other words, the sensor may be positioned off-axis to the light or energy source.

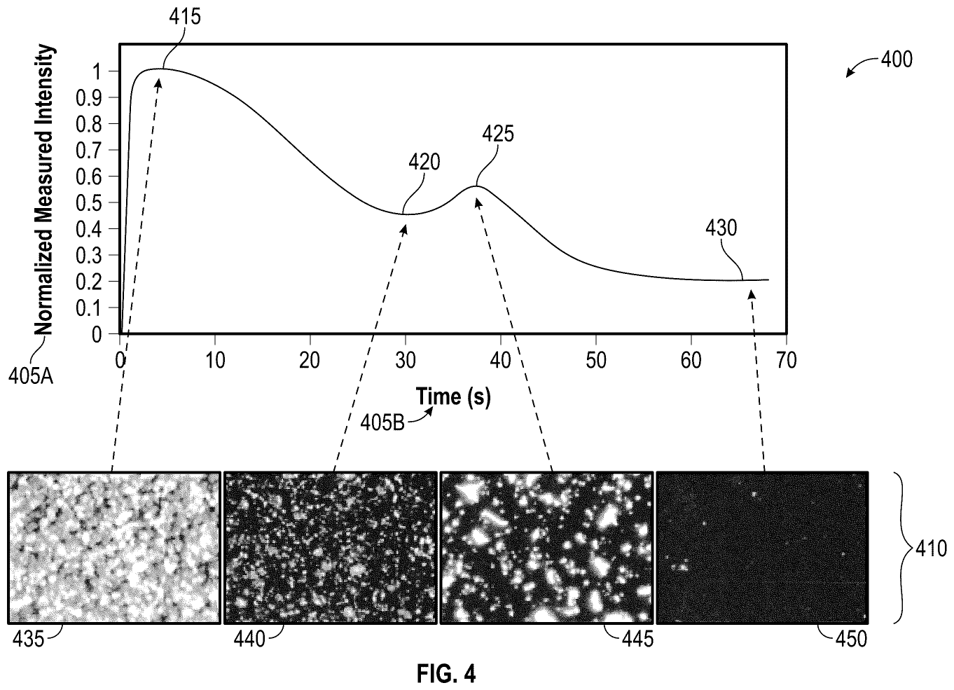

The optical melting states can be divided into 4 major states including starting phase, valley, peak, and steady states as the powder is heated eventually melts or sinters. These states can be depicted both graphically and as detected by a sensor in FIG. 4. The valley is the point where enough of the material is melting and increasing in reflectance to offset the decrease in measured intensity caused by the smoothening of the surface and, conversely, the peak is the point where the smoothening of the surface begins once again to have a greater effect on the measured intensity than the phase change of the material. This also suggests that most of the solid material is molten by the time it has reached peak. By using a dark-field configuration, the changing surface geometry and phase change have opposite effects on the measured intensity which makes it easy to observe the valley and peak transition points by using the optical sensor as depicted in FIGS. 5-7.

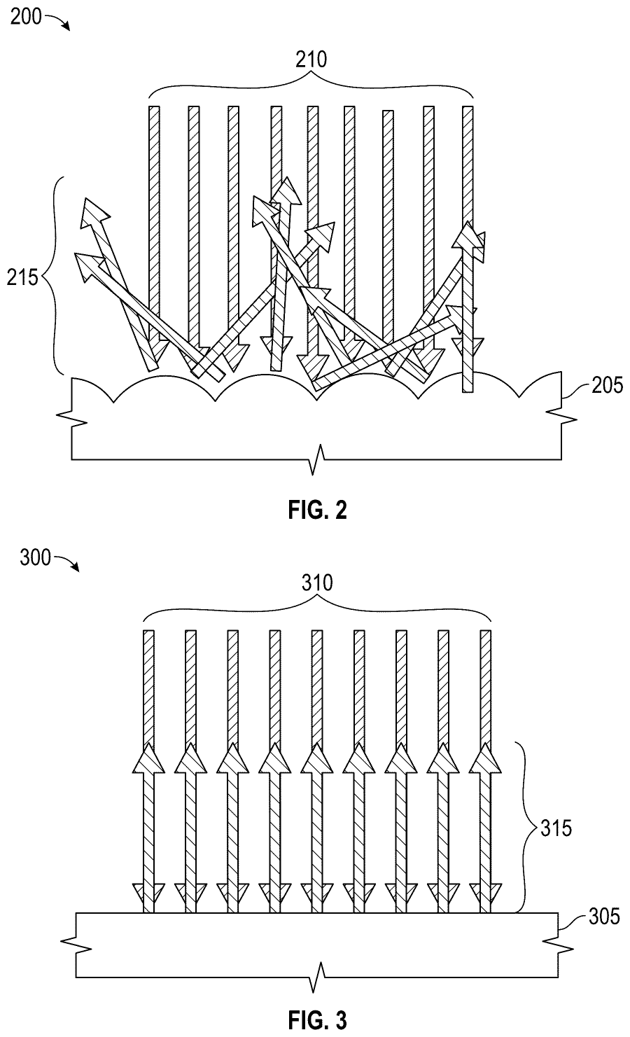

FIG. 2 illustrates example 200 light reflections 215 based on the geometry of surface 205. Light beam 210 may be directed towards surface 205 in a perpendicular direction. Alternatively, light beams 210 may be positioned at an angle other than 90 degrees from the length of surface 205. The observation of light reflections 215 may be captured by an optical sensor or other observation mechanism to determine the geometry of surface 205 based on the behavior of light reflections 215. Surface 205 may be rough as depicted in example 200. Rough surface 205 may be indicated by the lack of uniformity of light reflections 215. An optical sensor may be positioned to capture the behavior of light reflections 215. There may be a certain angle off-axis to the projector and/or other light source such that light reflections 215 lack uniformity an optical sensor should be able to capture some light reflections 215 (as depicted in FIGS. 5-7).

FIG. 3 illustrates example 300 light reflections 315 based on the geometry of surface 305. Light beams 310 may be directed towards surface 305 in a perpendicular direction. Alternatively, light beam 310 may be positioned at an angle other than 90 degrees. The observation of light reflections 315 may be captured by an optical sensor or other observation mechanism to determine the geometry of surface 205 based on the behavior of light reflections 315. Surface 305 may be smooth as depicted in example 300. Smooth surface 305 may be indicated by the uniformity of light reflections 315. An optical sensor may be positioned to capture the behavior of light reflections 315. Since light reflections 315 have uniformity, an optical sensor may not be able to capture some light reflections 315. This uniformity whether captured or not by the optical sensor based on the position of the sensor may indicate the geometry of surface 305.

FIGS. 2 and 3 depict an example of the behavior of light on two surfaces 205 and 305 based on their respective geometry. The reason the geometry of surfaces 205 and 305 may be important because the geometry may indicate the optical melting state of the powder used in 3-dimensional printers. In other words, the geometry of the powder may indicate how much of the powder has melted or changed physically by looking at the amount of light captured by an optical sensor. This connection is explained further in FIG. 4.

FIG. 4 illustrates a correlation between magnified image 410 of the powder bed and intensity profile 400. Intensity profile 400 may include normalized measured intensity on the x-axis 405A and time in seconds on the y-axis 405B. With these parameters in place, four significant portions of the graph may be depicted and may indicate a different optical melting state correlating to the major graph points along the scale of the normalized measured intensity. The correlating optical melting states of 415, 420, 425, and 430 are depicted in profile 400 and in image 410. Melting states 415, 420, 425, and 430 may represent localized regions of as indicated in changing of the graph. For example, melting state 415 may represent the values within that first peak and 420 may represent the values within the trough of the graph. Further 425 may represent the second smaller peak and 430 may the leveling portion of the Graph. Further, melting states 415, 420, 425 may use specific values with in those localized regions to indicate the melting states.

First in the timeline, starting phase 415 which has a normalized measured intensity at or near 1. Starting phase 415 may be depicted with image 435 includes a light granular image of the powder used in 3-dimensional printing. However, these methods may be used not only in 3-dimensional printing but in non-3-dimensional sintering. This image represents a time when no significant physical changes have been made with respect to the powder. Image 435 depicts a surface similar to surface 205 in FIG. 2. The light is reflected in various directions it can be easily captured by an optical sensor. Further, the brightness of the image, or the amount of white depicted may be an indication of the surface geometry which in turn may indicate the optical melting state of the powder.

The second significant portion of intensity profile 400 may include valley 420 where the normalized intensity has dropped. Correlating image 440 depicts powder that is darker and less granular. This image may depict the physical changes that have occurred with respect to the powder which may indicate the optical melting state of the powder. In the image there is still a dispersal of light detectable somewhat similar to surface 205 in FIG. 2 however there is less light indicating the surface may be becoming smoother.

The third significant portion of intensity profile 400 may be peak 425. Correlating image 445 depicts blob-like structures and the granular nature of the powder seems to be almost non-existent. Both the light portions and the dark portions seem to be larger as if some more uniformity has been obtained. This indicates the optical melting state may be at its peak. Image 445 is also somewhat similar to surface 205 depicted in FIG. 2 because the light is still being deflected in a way that the optical sensor is detecting.

The final significant portion of intensity profile 400 is finishing stage 430 of the optical melting state where image 450 depicts a dark image with little or no light portions. This seems to indicate that the surface geometry of the powder is similar to the surface 305 as depicted in FIG. 3. This also indicates that the optical sensor is positioned at an angle off-axis to the projector or light source in a dark field position as depicted in FIGS. 5-7. This may indicate that no further changes will likely be made concerning the powder even with further heating. The optical sensor may further detect optical inflection points as the optical sensor detects changes that do not necessarily include a phase change of the powder.

As an optical sensor, equipped with a processor, communicates these images with a computing device that can communicate with a 3-dimensional printer alteration in the operation of the printing may occur to adjust the printing and reduce errors in the printing of a 3-dimensional object. Furthermore, artificial intelligence may be used to interpret the images to more precisely determine the optical melting state of the powder. To that end, the optical melting points may be adjusted to include optical inflection points as the optical sensor detects changes that do not necessarily include a phase change of the powder. Also, artificial intelligence may be used to determine the best types of adjustment made by the 3-dimensional printer to create a more desirable, repeatable 3-D object.

FIG. 5 illustrates an optical observation configuration 500 for observing powder melting. Configuration 500 includes projector 505 positioned directly over the top of the observed powder bed 525. Projector 505 may emit a pulsed projected light beam 515. Projector 505 may emit a high-intensity LED light beam 515 extending from projector 505 to powder bed 525. The light exposure time in a Large Area Projection Sintering printer (“LAPS”) may range from 1 to 7.5 seconds. Configuration 500 also includes optical sensor 510 which is depicted as a camera that is oriented approximately 40 degrees from orthogonal to build plane. Approximately, in this context is plus or minus 10 degrees. Optical sensor 510 may capture periodic images to detect the change in the surface geometry or surface profile associated with an optical melting state. Optical sensor direction 520 is the orientation of optical sensor 510. The time duration of the powder bed 525 was monitored may and may be approximately 25 seconds in a Large Area Projection Sintering printer (“LAPS”) to best detect the optical melting states. Approximately, in this context means plus or minus 5 seconds. The optical melting states can be divided into 4 major states, starting phase, valley, peak, and steady state as the powder becomes smoother. The valley is the point where enough of the material is melting and increasing in reflectance to offset the decrease in measured intensity caused by the smoothening of the surface and, conversely, the peak is the point where the smoothening of the surface begins once again to have a greater effect on the measured intensity than the phase change of the material. This also suggests that most of the solid material is molten by the time it has reached the peak. By using a dark-field configuration of the optical sensor in relation to projector 505, the changing surface geometry and phase change have opposite effects on the measured intensity which makes it easy to observe the valley and peak transition points. This is all based on the idea that the geometry of the powder bed determines the direction in which the projector light 515 is reflected.

These observations are useful when developing methods for analyzing part-level images, such as for identifying an appropriate mesh size for state detection. It is important to have an element size large enough to capture both bright spots and their surrounding darker regions after the peak. At peak, the material is mostly molten and beginning to flow and fill low spots. This is best captured by a spatial average of bright spots and darker regions which can be calculated as the average intensity of a mesh element. If the mesh is too fine, bright spots and their neighboring darker regions may be separate elements. This is problematic because it is important to apply energy to both the smooth and uneven regions to efficiently facilitate flow between the two. Different element sizes could be chosen for the mesh. Element sizes may play a role. An element size of 380 μm may be large enough to ensure that the bright-dark region dynamics were captured within each element.

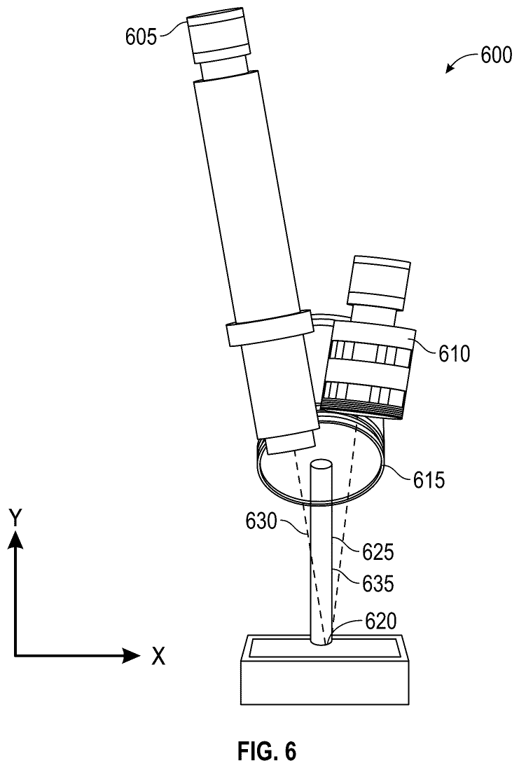

FIG. 6 illustrates an optical observation configuration 600 for observing powder melting on powder bed 620. Configuration 600 may include optical sensor 605 depicted as a magnified camera positioned near optical sensor 610 depicted as a standard camera and both optical sensor 605 and optical sensor 610 may be positioned near high-intensity LED light 615. Both sensors 605 and 610 are positioned orthogonally to the plane that is being observed helping keep the entire field of view in focus. LED light 615 was positioned so that light beam 625 would be projected in such a way that cameras 605 and 610 would be in a dark-field orientation. Camera direction 630 is of optical sensor 605. Camera direction 635 is the angle of optical sensor 610. The orientation of optical sensor 605 and in comparison, to high intensity LED 615 is to position the camera in a dark-field configuration to best observe the optical melting states.

The optical melting states can be divided into 4 major states starting phase, valley, peak, and steady state as the powder becomes smoother. The valley is the point where enough of the material is melting and increasing in reflectance to offset the decrease in measured intensity caused by the smoothening of the surface and, conversely, the peak is the point where the smoothening of the surface begins once again to have a greater effect on the measured intensity than the phase change of the material. This also suggests that most of the solid material is molten by the time it has reached the peak. By using a dark-field configuration, the changing surface geometry and phase change have opposite effects on the measured intensity which makes it easy to observe the valley and peak transition points.

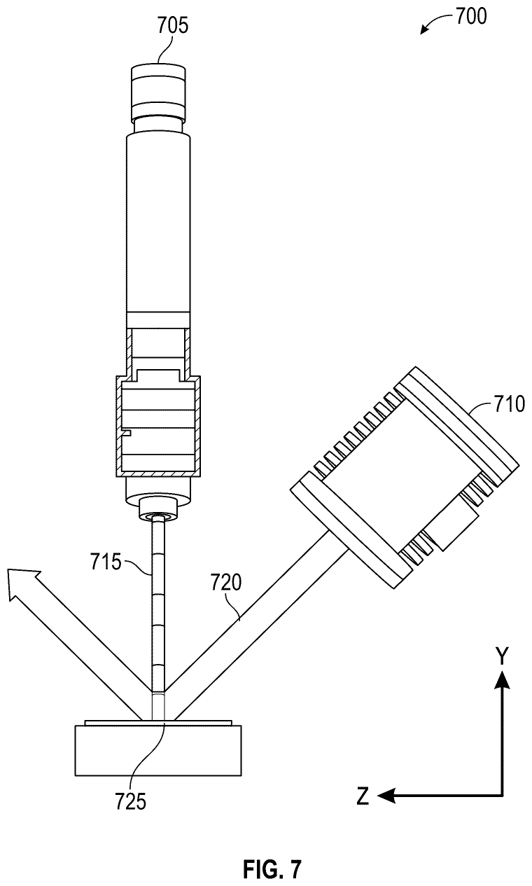

FIG. 7 illustrates an optical observation configuration 700 for observing powder melting on powder bed 725. Configuration 700 may include a magnified optical sensor 705 depicted as a camera with its camera direction 715. Configuration 700 may also include high-intensity LED light 710 with light beam 720 depicted. The orientation of magnified camera 705 in comparison to high-intensity LED 710 is to position the camera in a dark-field configuration to best observe the optical melting states.

The optical melting states can be divided into 4 major states, starting phase, valley, peak, and steady state as the powder becomes smoother. The valley is the point where enough of the material is melting and increasing in reflectance to offset the decrease in measured intensity caused by the smoothening of the surface and, conversely, the peak is the point where the smoothening of the surface begins once again to have a greater effect on the measured intensity than the phase change of the material. This also suggests that most of the solid material is molten by the time it has reached the peak. By using a dark-field configuration, the changing surface geometry and phase change have opposite effects on the measured intensity which makes it easy to observe the valley and peak transition points.

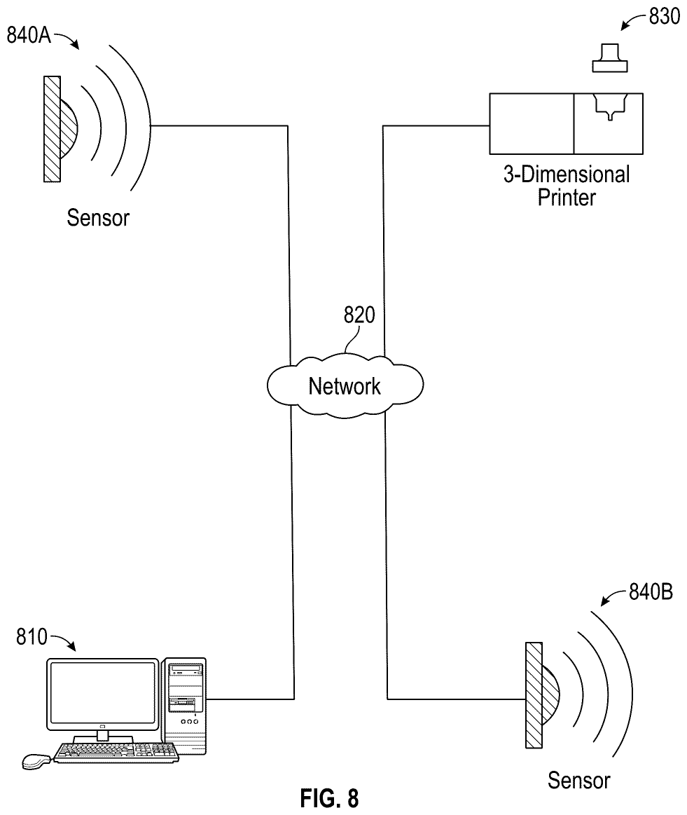

FIG. 8 illustrates a schematic diagram of the observation of powder melting via melt detection system 800. System 800 may include computing device 810, sensors 840A-B, and Large Area Projection Sintering (“LAPS”) printer 830. Sensors 830 may communicate with computing device 810 and LAPS printer 830 through network 820. Network 820 may be a local network system (LAN), wide area network (WAN), personal area network (PAN), campus area network (CAN), cloud base network, or other systems known in the art.

Computing devices 810 may include the series of tasks needed to produce a 3D object. This includes information on the dimensions of the particular 3D object, the slicing information, the printing parameters, the material data, the support structures, and the printing calibration and configuration needed. Computing device 810 may be able to receive and interpret input from one or more sensors 840A and 840B, either directly or through network 820. Once input is received from one or more sensors 840A and 840B computing device 810 may be able to interpret the data be it an image or data and send updated printing parameters to LAPS printer 830 based on the data received. Sensors 840A-B may include one or more types of cameras, including but not limited to optical cameras, thermal cameras, high-speed cameras, magnified cameras, high-speed X-rays, scanning electron microscope (“SEM”), etc. Sensors 840A-B may also be a photodiode.

For example, sensor 840A may be a camera that depicts and/or recognizes the different optical melting states indicated and may indicate to computing device 810 that the powder is at peak 425 (as depicted in FIG. 4). Alternatively, sensor 840A may send image 445 (as depicted in FIG. 4) and computing device 810 then determines the optical melting state is at peak 425 (as depicted in FIG. 4). Computing device 810 may then relay the information received from sensor 840A to LAPS printer 830. LAPS printer 830 may then adjust the exposure time, the temperature, and/or the projection geometry according to the input received from computing device 810. LAPS printer 810 may include a processor to be able to receive and process input data directly from sensors 840A and 840B or through cloud network 820. Computing device 810 may use machine learning such as artificial intelligence (“AI”) to adjust how to best react to information received from sensors 840A and 840B

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A method for observing and controlling powder melting in 3-dimensional printing comprising:
receiving, by a 3-dimensional printer, input from a computing device,
initiating, by the 3-dimensional printer, melting of powder on a powder bed,
receiving, by the 3-dimensional printer, real-time feedback based on information from one or more optical sensors,
adjusting output, by the 3-dimensional printer, based on feedback from one of the optical sensors, and
sintering, by the 3-dimensional printer, based on the adjustments.

2. The method of claim 1, wherein the real-time feedback based on one or more optical sensors includes receiving, by the 3-dimensional printer, an optical melting state.

3. The method of claim 2, wherein the optical melting state received by the 3-dimensional includes one of starting phase, valley, peak, or steady state.

4. The method of claim 3, wherein one of the one or more optical sensors is a camera.

5. The method of claim 4, wherein the optical sensor is positioned off-axis to the energy source.

6. The method of claim 5, wherein the optical sensor is positioned in a dark-field position.

7. The method of claim 6, wherein the optical sensor captures images of the powder.

8. The method of claim 7, wherein the images captured are used to determine an optical melting state of the powder in local regions of the powder.

9. The method of claim 8, wherein the computing device interprets the optical melting state based on images captured by the optical sensor to determine the optical melting state.

10. The method of claim 9, wherein the computing device interprets the images using artificial intelligence to determine the optical melting state based on images captured by the optical sensor to determine the optical melting state.

11. The method of claim 10, wherein the type of artificial intelligence used is machine learning.

12. The method of claim 9, wherein the computing device communicates the optical melting state to the 3-dimensional printer.

13. The method of claim 9, wherein after determining the optical melting state of the powder, the computing device communicates one or more adjustments to be made to optimize the sintering by the 3-dimensional printer.

14. The method of claim 8, wherein the optical sensor interprets the optical melting state of the powder based on the images captured to determine the optical melting state.

15. The method of claim 12, wherein the optical sensor communicates the optical melting state of the powder to the 3-dimensional printer.

16. The method of claim 12, wherein after determining the optical melting state of the powder, the optical sensor communicates one or more adjustments to the 3-dimensional printer to optimize the sintering.

17. The method of claim 1, wherein adjusting output includes changing a duration of an energy source on a powder by the 3-dimensional printer.

18. The method of claim 1, wherein adjusting output includes changing the intensity of an energy source on a powder by the 3-dimensional printer.

19. The method of claim 1, wherein the 3-dimensional printer is a Large Area Projection Sintering printer.

20. The method of claim 1, wherein the 3-dimensional printer is a selective laser sintering printer.
